(19) United States
(12) Patent Application Publication
(10) Pub. No.: US 2006/0008057 A1
(43) Pub. Date: Jan. 12, 2006

(54) Structure and method for shielding radiation in an x-ray generator

(75) Inventor: Premjit J. Daniel, Bangalore (IN)

Correspondence Address: JAMES D IVEY, 3025 TOTTERDELL STREET, OAKLAND, CA, 94611-1742, US

(73) Assignee: General Electric Company, Schenectady, NY (US)

(21) Appl. No.: 10/889,753

(22) Filed: Jul. 12, 2004

(51) Int. Cl. H01J 35/16

(52) U.S. Cl. 378/203

(57) ABSTRACT

A structure for shielding radiation in an X-ray generator comprises at least one first layer constructed of a first substance and at least one second layer constructed of a second substance wherein the first substance comprises substantial thermal transfer property and the second layer comprises substantial radiation shielding property. A method of shielding radiation in an X-ray generator and an X-ray generator are also described and claimed.

### FIELD OF THE INVENTION

This invention relates generally to radiation shielding, and more particularly, to structures and methods for shielding radiation in an X-ray generator.

### BACKGROUND OF THE INVENTION

An X-ray generator e.g., a Tube Head (having an X-ray tube and a generator within a housing) is used widely as a compact source for X-ray generation in diagnostic medical imaging, industrial inspection systems, security scanners, etc.

During X-ray generation, the X-ray tube generates X-rays in all directions around a focal spot requiring X-ray exposure. Continuous exposure to even low levels of X-ray radiation may cause undesirable health effects to a user in an X-ray environment. Therefore, sufficient shielding and thereby prevention of exposure to X-ray radiation e.g., in locations other than the focal spot becomes necessary to safeguard the user from undesirable health hazards.

Regulatory requirements demand for a radiation leakage specification of about 0 to 2 mili-Roentgens per hour at the generator equipment surface.

Moreover, during high power X-ray generation, for example, the X-ray generator may be operated at a voltage e.g., more than 70 kV and at a temperature exceeding 200 degrees Celsius at the anode. X-ray generators normally use insulating oil (e.g., mineral oil) filled around the anode to act as a coolant to dissipate heat and also provide insulation around the anode.

Known methods for providing radiation shielding to an X-ray generator include securing a lining comprising a lead sheet to the inner surface of the housing and painting the lead sheet using special paints to avoid contamination of the insulating oil filled around the anode. Although the lead sheet lining provides sufficient radiation leakage resistance, the housing requires a large surface area to accommodate a lining of sufficient thickness, which may result in much less compact system for the X-ray generator. Moreover, securing a lead sheet lining inside the housing reduces the rate of heat transfer from the housing and does not prevent high voltage electronic circuitry mounted within the housing from being exposed to X-ray radiation. The poor workability of lead sheet does not allow for shaping to minimum and desired cross section and thereby may not provide adequate clearance to prevent generation of arcing phenomenon within the X-ray generator. Furthermore, securing of the lead sheet to a housing having a non-uniform geometry may become difficult and the use of a special paint for the lead sheet to prevent oil contamination may become expensive.

Another known method for providing a radiation shield to an X-ray generator includes assembling a shielding part cast from a lead content alloy having about 25-wt % of lead, around the X-ray tube. Although this arrangement prevents high voltage electronic circuit located within the housing, from being exposed to the X-rays, higher thickness of shielding part becomes necessary to compensate for the equivalent lead thickness and thereby provide a sufficiently radiation leak-proof shielding. Further more, the heat flow across the shield becomes reduced as the alloy used has a low thermal conductivity comparable to that of lead. This results in a higher temperature at the heat source side as given by the equation:
Q=K*A*(TI−T2)/L
Wherein:
In the above equation,
“Q” is the amount of heat flow;
“K” is the Thermal Conductivity of the alloy;
“A” is the cross sectional area of the shielding part;
“L” is the length of the shielding part;
“T1” is the temperature at source side; and
“T2” is the temperature at ambient side.

Another method for providing radiation shielding, particularly to X-ray and gamma radiations, is disclosed in U.S. Pat. No. 4,795,654 issued Jun. 3, 1989 to Teleki. The U.S. Pat. No. 4,795,654 discloses a shielding structure comprising at least two layers, and possibly three layers of material, provided in specific order from the side in which the radiation is received. The first layer has K-edge and L₁-edge levels of a first range. The second layer in order has K-edge levels between the K-edge and L₁ edge levels, and lower than a secondary radiation level that is emitted by the first layer. A third layer in order has a K-edge level between the K-edge and L₁-edge levels of the second layer. Although this method provides a much less thick and low weight radiation shielding, the radiation shielding does not posses appreciable thermal transfer property and hence may result in insufficient heat transfer leading to formation of hot spots along the tube length when used in an X-ray generator. Moreover, disclosed method suggests use of lead in the first layer, which may result in contamination of the insulating oil filled around the anode.

Thus, these known methods and structures do not allow for providing a radiation shielding structure (i) having a compact design for the X-ray generator with lower thickness and weight of the shielding material (ii) possessing superior heat transfer properties and thereby prevent hot spots formation along the tube length (iii) prevent contamination of the insulating oil and (iv) enable easy formability to minimum cross-section and desired shape to provide adequate clearance and thereby prevent arcing phenomenon within an X-ray generator.

### BRIEF DESCRIPTION OF THE INVENTION

The above-mentioned shortcomings, disadvantages and problems are addressed herein, which will be understood by reading and studying the following specification.

In one embodiment, a structure for shielding radiation in an X-ray generator is provided. The structure includes at least one first layer comprising a first substance having a thermal transfer property and at least one second layer comprising a second substance having a radiation shielding property.

In another embodiment, a method for shielding radiation in an X-ray generator is provided. The method includes providing at least one first layer for transferring heat from near an X-ray tube to a location at a distance. At least one second layer is provided in combination with the first layer for shielding the radiation from the X-ray tube.

In yet another embodiment, an X-ray generator is provided. The X-ray generator comprises a housing accommodating an X-ray tube there within. A means for shielding radiation is disposed in-between the X-ray tube and the housing. The means for shielding radiation is configured to transfer heat and electric field near the X-ray tube to a location at a distance.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 shows the perspective cross section of the structure for shielding radiation in an x-ray generator according to one embodiment.

FIG. 2 shows the structure of FIG. 1 in assembly state within an X-ray generator according to an embodiment.

FIG. 3 shows the assembly of cooling arrangement within the X-ray generator according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

Various embodiments provide a structure and method for shielding radiation in an X-ray generator, especially a Tube Head comprising an X-ray tube and a generator within a housing. However, the embodiments are not so limited, and may be implemented in connection with other systems such as, for example, in gamma ray detectors, various other nuclear and X-ray devices.

In various embodiments, a structure for shielding radiation in X-ray generator is provided, wherein the structure comprises at least one first layer to facilitate transfer of heat generated from the X-ray tube (e.g., at anode), to a location away from the X-ray tube, and at least one second layer to provide shielding from the X-rays generated from the X-ray tube. In particular, the structure comprises at least one first layer comprising a first substance and at least one second layer comprising a second substance wherein the first substance transfers heat from the X-ray tube to a location at a distance, and second substance provides shielding of radiation generated from the X-ray tube. However, in other embodiments, a third layer comprising one of a third or first substance for structurally strengthening the second layer may be provided.

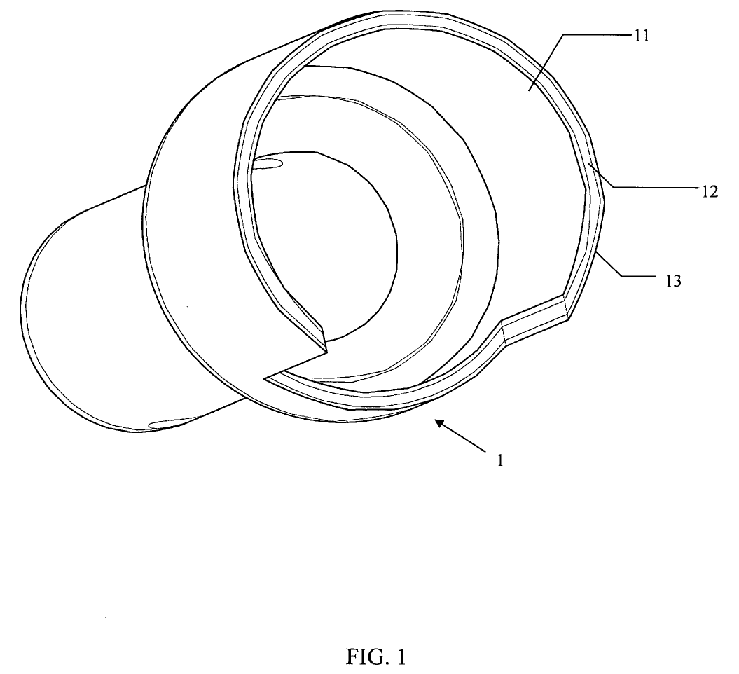

FIG. 1 shows an exemplary view of a structure 1 for shielding radiation in an X-ray generator according to one embodiment. The structure 1 includes at least one first layer 11 constructed of a first substance and at least a second layer 12 constructed of a second substance.

In an embodiment, a third layer 13 constructed of a third or first substance is provided in combination with the first and second layers.

In an example, the first substance may include material having substantial thermal transfer property.

In other examples, the first substance may include material having both substantial thermal transfer (e.g., heat dissipating) and electrical conducting properties. The first substance comprises at least one of copper or a copper alloy. In other examples, the first substance may include materials such as tin, aluminum, etc., having both thermal transfer and electrical conducting properties.

It should be noted that the use of a material having substantial electric conductivity in addition to thermal transfer property provides for transfer and thereby removal of electrostatic charges that get accumulated on the surface of the first layer 11 from the insulating oil.

The second substance includes material having a substantial radiation shielding property. In one example, the second substance includes a lead content material e.g., a lead sheet. The second substance may include various types and forms of radiation shielding materials suitable for use in combination with the configured first and third layers 11 and 13.

The third layer 13 is configured to provide structural support to the second layer. The third layer 13 may be constructed of the material of first substance or constructed from a third substance e.g., at least one of aluminum or aluminum alloy.

The elastic modulus of material of the first layer 11 and the third layer 13 is in the range of, for example, five to 7 times that of the second layer for providing sufficient reinforcing strength to the second layer.

In an example, the first, second and third layers 11, 12 and 13 in the form of sheets, are shaped independently to required form, by spinning around a mandrel. The shaped sheets are then bonded by a thin layer of adhesive such as, for example, an epoxy adhesive, in-between the layers.

In other examples, the sheets are individually formed to required shape by deep drawing process and then bonded together using an adhesive such as an epoxy adhesive.

In an example, the first layer 11 may be curled along the edges to cover the second layer 12 and as well as to prevent relative slippage of the layers.

In yet another example, the first and third layers 11 and 13 are shaped to required form by spinning process. The shaped layers are held together with a gap in-between, by use of fixtures. The gap is filled with lead pellets or granules and controlled heating is carried out to make the lead homogeneous in-between the layers. This method could be implemented in devices in which difficulty in assembling the layers exist due to dimensional variation in the second layer, especially when lead is used.

It should be noted that melting of lead above its melting point and then cooling may result in increased porosity in lead which may cause radiation leak through the second layer. Heating is controlled such that porosity generation and hence radiation leakage is substantially minimized.

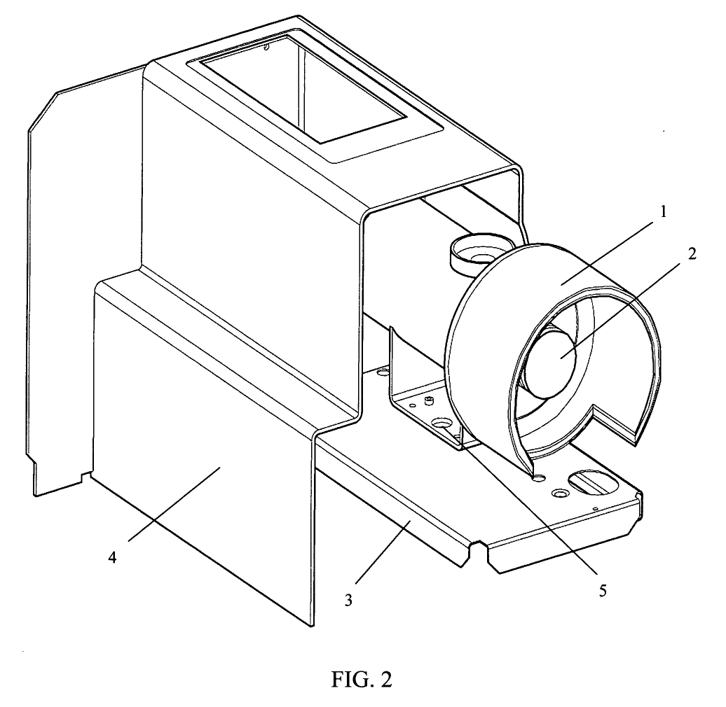

FIG. 2 shows the structure 1 for shielding radiation, in assembly state with an X-ray generator. The X-ray generator includes an X-ray tube 2 mounted on a base 3 and accommodated within a housing 4. An insulating oil (e.g., mineral oil) is filled within the housing to provide insulation and also act as a coolant for X-ray generator. The structure 1 for shielding radiation, is secured in-between the X-ray tube 2 and the housing 4 by one or more suitable methods.

For example, in one method, the structure 1 is secured to the base by screw connection 5.

It is to be noted that the assembly of the structure 1 for shielding radiation, in-between the X-ray tube 2 and the housing 4 prevents electronic circuits (not shown) mounted within the housing 1 from being exposed to X-rays.

The shape of the structure 1 for shielding radiation may be configured to have a minimum cross-sectional area, which would enable thermal and electric field transfer by the first layer 11 (FIG. 1) without arcing and generation of hot spots along the length of the X-ray tube 2.

In one example, the structure 1 for shielding radiation may be formed to substantially circular cross-section.

It should be noted that the circular cross section for the structure 1 shielding radiation provides minimum cross section, improved section modulus, enhanced electric field distribution capability to the first layer 11.

In other examples, the structure 1 for shielding radiation may be formed to non-circular shapes by various other methods or processes, such as deep drawing etc., This would enable implementation of the structure for shielding radiation in X-ray generators wherever use of circular shapes is not possible or difficult.

During assembly, the first layer 11 is disposed at the source side of radiation (e.g., at the side of X-ray tube 2) and the third layer 13 is disposed at the side requiring shielding (e.g. outside of housing 4). The second layer 12 is disposed in-between the first and third layers 11 and 13.

The thickness of various layers may be set according to the requirements. For example, the thickness of the first layer 11 may be set based on the amount and rate of heat required to be removed from the insulating oil. The first layer 11 also provides structural rigidity to the second layer 12 and therefore, the thickness of the first layer 11 may be set also considering the amount of strengthening required for the second layer 12. It is to be noted that the first layer 11 also prevents contamination of the insulating oil by the second layer 12 (shielding material).

The thickness of the second layer 12 may be set based on the amount of material required for shielding the radiation to meet the required radiation leakage-proof standards.

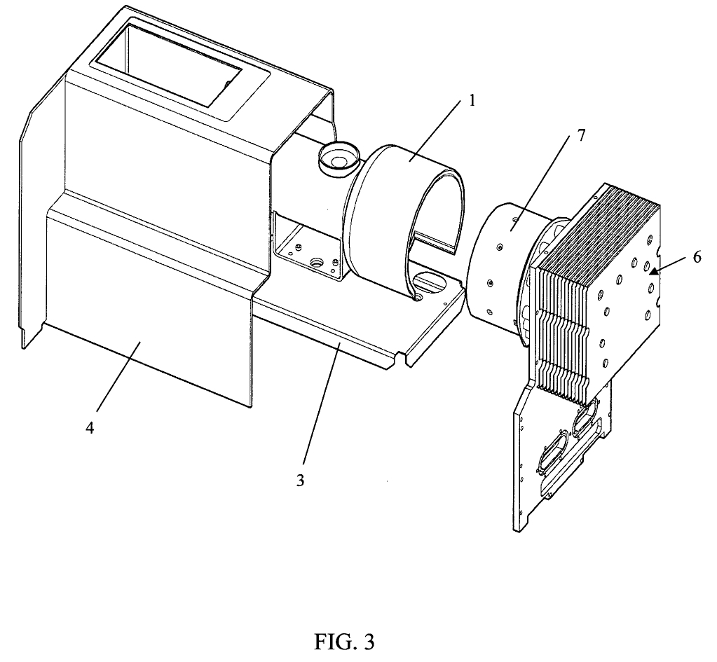

FIG. 3 shows another embodiment wherein, a cooling means 6 is coupled to the structure 1 for shielding radiation. In one embodiment, the cooling means 6 comprises a copper sleeve 7 embedded with a plurality of heat pipes (not shown). The copper sleeve 7 is secured to the structure 1 for shielding radiation, for carrying away the heat transferred by the first layer 11 from the insulating oil. This arrangement maintains required optimum temperature of the insulating oil within the housing in addition to providing effective radiation shielding.

Thus, various embodiments provide structures and methods for shielding radiation in an X-ray generator. Further embodiments provide an X-ray generator having a construction to provide effective radiation shielding and also maintain optimum temperature around the X-ray tube.

While the invention has been described in terms of various specific embodiments, those skilled in the art will recognize that the invention can be practiced with modification for example, the first layer and third layers may have material having both thermal transfer and electrical conducting properties, such as steel, chromium, nickel etc., The second layer may have materials such as rhenium, osmium etc. However all such modifications are deemed to have been covered within the spirit and scope of the claims.

We claim:

1. A structure for shielding radiation in an X-ray generator comprising:
at least one first layer comprising a first substance;
at least one second layer comprising a second substance,
wherein:
said first substance comprises at least one material having substantial thermal transfer property; and
the second substance comprises at least one radiation shielding material.

2. A structure according to claim 1 further comprises at least one third layer comprising a third substance.

3. A structure according to claim 1 further comprises at least one third layer comprising the first substance.

4. A structure according to claim 1 wherein the first substance further comprises electrical conducting property.

5. A structure according to claim 1 wherein the first substance is one of copper or an alloy thereof.

6. A structure according to claim 1 wherein the second substance is lead.

7. A structure according to claim 6 wherein the lead has a purity in the range of about 90 percent to 100 percent.

8. A structure according to claim 7 wherein the purity in the range of 94 percent to 97 percent.

9. A structure according to claim 2 wherein the third substance is aluminum or an alloy thereof.

10. A structure according to claim 3 wherein the first and/or third layer comprises an elastic modulus of about 7 to 10 times more than the elastic modulus of the second layer.

11. A method for shielding radiation in an X-ray generator comprising:
configuring at least one first layer for transferring heat from an X-ray tube to a distant location; and
configuring at least one second layer in combination with the first layer for shielding radiation from the X-ray tube.

12. A method according to claim 11 further comprising configuring at least one third layer for backing the second layer.

13. A method according to claim 11 comprising configuring the layers from a first side to a second side wherein:
the first side is a source side for radiation; and
the second side is a shielding side for radiation.

14. A method according to claim 11 wherein the first layer comprises one of copper or an alloy thereof.

15. A method according to claim 11 wherein the second layer comprises a lead content material.

16. A method according to claim 13 wherein the third layer comprises one of aluminum or an alloy thereof.

17. A method according to claim 16 wherein configuring the first layer comprises a circular configuration.

18. An X-ray generator comprising:
a housing accommodating an X-ray tube there within;
a means for shielding radiation, disposed in-between the X-ray tube and the housing;
said means configured to transfer heat and electric field near the X-ray tube to a location at a distance.

19. The X-ray generator according to claim 18 wherein the means for shielding radiation comprises a circular cross-section.

20. An X-ray generator according to claim 18 further comprising a cooling means coupled to the means for shielding radiation.

21. An X-ray generator according to claim 19 wherein the cooling means comprises a plurality of heat pipes.

22. A method of making a radiation shield comprising:
shaping at least a pair of sheets individually to a desired cross-section;
maintaining the sheets together with a gap in-between;
filling the gap with a radiation shielding material; and
heating the radiation shielding material to a predetermined temperature
wherein at least one of the sheets has at least one of a substantial thermal transfer property and electric conductivity.
